(19) United States
(12) Patent Application Publication
(10) Pub. No.: US 2014/0355142 A1
(43) Pub. Date: Dec. 4, 2014

(54) VOICE COIL MOTOR

(71) Applicant: SILITECH TECHNOLOGY CORP., New Taipei City (TW)

(72) Inventor: CHIH-JUNG HUNG, TAINAN CITY (TW)

(21) Appl. No.: 13/909,171

(22) Filed: Jun. 4, 2013

(51) Int. Cl. G02B 7/04

(52) U.S. Cl. CPC G02B 7/04
USPC 359/824; 29/25.35

(57) ABSTRACT

A VCM actuator for a lens and driving the lens for focusing includes a fixed module, a mobile module and a spring module. The fixed module includes a case and the magnet module is disposed along the inner side of the case. The mobile module includes a lens holder and a coil looping the lens holder. The lens holder is movably disposed in the case and the coil is fastened to the lens holder positioning to the magnet module. The spring module abuts the fixed module and mobile module. The case has an opening and along the rim of each corner of the opening a magnet guiding tab is formed. The guiding tabs extend between the lens holder and coil and are positioned toward the gaps between the magnet module, and each magnet guiding tab has a backbone and two wing portions extending from the backbone.

### BACKGROUND

1. Field of the Invention

The instant disclosure relates to a voice coil motor; in particular, to a voice coil motor actuator.

2. Description of Related Art

Conventional voice coil motor (VCM) includes a metallic frame having magnets within the frame. However, the electromagnetic field generated by the coil at the corner region cannot interact with the magnets because the magnets are absent around the corners of the frame. Therefore, the electromagnetic field is wasted and the driving efficiency is reduced. The power consumption can be relatively higher especially in a compact sized VCM.

It is important to solve the abovementioned issue by structural design. A magnet seat for an auto focus camera module is disclosed by a prior art, TW 201219956. In FIG. 3 of this specification, a bended L-shaped tab 40 is formed on each corner of a frame 30. The tabs 40 extend to a receiving space 41 defined by a seat 34 and a coil 38. The L-shaped tabs 40 are positioned to a space defined by two magnets 32 which is beyond the coil 38. Preferably, the L-shaped tabs 40 are integrally formed with the frame 30 and increase the magnetic efficiency driven by the electromagnetic field around the corners of the coil 38.

Like poles of magnets and the coils repel each other. The virtual pole of coils is generated by the current going through the coil. So the repelling force between the magnets and the coil depend on the current, the corresponding area and the magnetic flow. The forces generated by the VCM and the current going through the coil are in positive proportion. The corresponding area between the coil and magnets and the magnetic flow also affect the forces. However, the L-shaped tabs are only positioned to the spaced defined by the magnets and separated by the coil. Thus, there is room for improvement of the magnet seat provided by the prior art. An accurate magnetic field orientation and a denser flux to increase the pushing force are the concerns of the instant disclosure.

### SUMMARY OF THE INVENTION

The instant disclosure provides a voice coil motor actuator for a lens and driving the lens for focusing, including a fixed module, a mobile module and a spring module. The fixed module includes a case and a magnet module disposed along the inner side of the case. The mobile module includes a lens holder and a coil looping the lens holder. The lens holder is movably disposed in the case and the coil is fastened to the lens holder corresponding to the position of the magnet module. The spring module abuts the fixed module and the mobile module. The case has an opening and along the rim of each corner of the opening a magnet guiding tab is formed. The guiding tabs extend between the lens holder and the coil and are positioned toward the gaps between the magnet module, and each magnet guiding tab has a backbone and a pair of wing portions extending therefrom.

The instant disclosure also provides another voice coil motor actuator for a lens and driving the lens for focusing, including a fixed module, a mobile module, a spring module and a dust proof ring. The fixed module includes a case and the magnet module is disposed along the inner side of the case. The mobile module includes a lens holder and a coil looping the lens holder. The lens holder is movably disposed in the case and the coil is fastened to the lens holder positioning to the magnet module. The spring module abuts the fixed module and the mobile module. The case has an opening and along the rim of each corner of the opening a magnet guiding tab is formed. The guiding tabs extend between the lens holder and the coil and are positioned toward the gaps between the magnet module, and each magnet guiding tab has a backbone and a pair of wing portions extending therefrom. The voice coil motor actuator also includes a base coupled to the bottom of the case. The dust proof ring is coupled to the base and an annular dust proof groove is formed between the dust ting and the base.

The instant disclosure further provides a method of manufacturing the voice coil motor actuator for a lens and driving the lens for focusing. The method includes (a) providing a case, a spacer, an upper spring and a magnet module. The case acts as the foundation and the spacer, upper spring and magnet module are disposed in succession in the case as a first half product. (b) A lens holder, a coil and a lower spring are provided. The lens holder acts as the foundation and the coil and the lower spring are disposed in the lens holder in succession as a second half product. (c) A base is provided and the first and second half products are assembled to form a provisional voice coil motor actuator. (d) The semi-finished voice coil motor actuator is cleaned by blowing air and rinsing with liquid. A dust proof ring is coupled to the base and elevates the lens holder. The lower spring is therefore deformed to create a pressure on the lens holder.

In conclusion, the VCM actuator has magnet guiding tabs formed at the corners of the case and each magnet guiding tab has the pair of wing portions extending from the backbone. The magnetic field efficiency, driven by the electromagnetic field, of the coil at the corner region is enhanced thereby. The extending wing portions guide the magnetic field and condense the flux. The direction of magnetic field is ensured by the presence of the magnet guiding tabs and the flux is denser. The VCM actuator generates more stable and powerful pushing force under the same amount of current. Furthermore, the plurality of the contacting faces of the lens holder is in structural cooperation with the guiding tabs. Specifically, the magnet guiding tabs and the contacting faces of the lens holder are contiguous such that the VCM actuator can sustain stronger torsion and impact. Moreover, the annular dust proof groove formed between the dust proof ring and the base can collect or attract foreign particles therein and improve dust collection.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE DRAWINGS

FIG. 1 is a perspective view of a voice coil motor actuator of the instant disclosure;

FIG. 2 is an exploded perspective view showing a first half product of a voice coil motor actuator of the instant disclosure;

FIG. 3 is an exploded perspective view showing a second half product of a voice coil motor actuator of the instant disclosure;

FIG. 4 is an exploded perspective view of a voice coil motor actuator of the instant disclosure;

FIG. 5 is a rear through view of a voice coil motor actuator of the instant disclosure;

FIG. 6 is a cross-sectional view of a voice coil motor actuator of the instant disclosure;

FIG. 7 is a perspective view showing a dust proof ring inserted to a base of a voice coil motor actuator of the instant disclosure;

FIG. 8 is a cross-sectional view showing a dust proof groove formed between a dust proof ring and a base of a voice coil motor actuator of the instant disclosure;

FIG. 9 is a cross-sectional view showing a dust proof ring inserted to a base of a voice coil motor actuator in an alternate embodiment of the instant disclosure; and

FIG. 10 is a cross-sectional view of FIG. 9 when a dust proof dust proof ring abuts a lens holder and a lower spring deforms.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

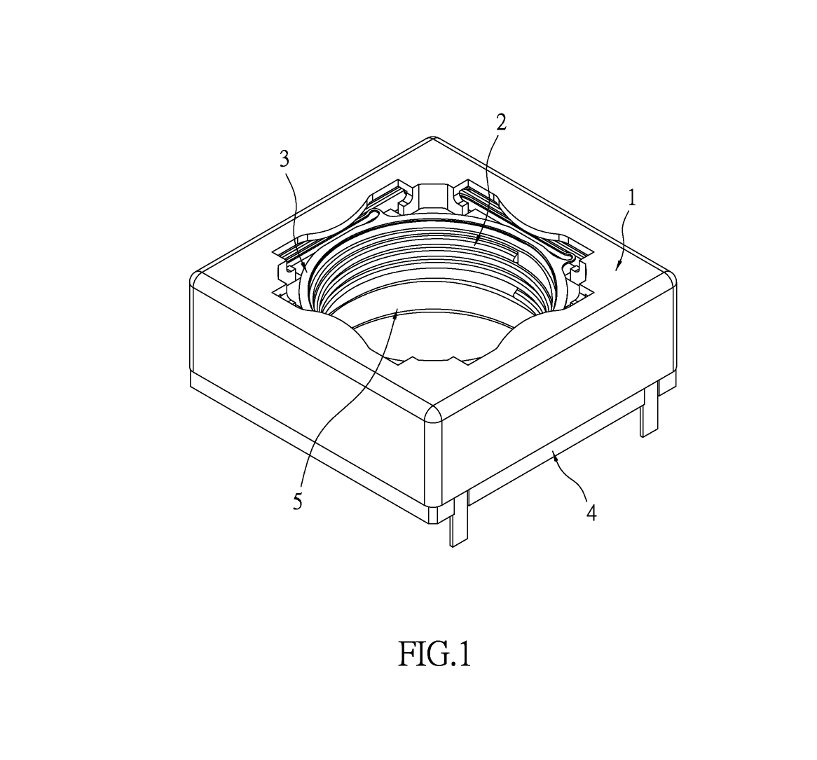

Please refer to FIG. 1 illustrating a perspective view of a voice coil motor actuator of the instant disclosure. A lens can be installed in the voice coil motor actuator and driven thereby for focusing. The voice coil actuator includes a fixed module 1, a mobile module 2 and a spring module 3. The voice coil motor actuator may further include a base 4 and a dust proof ring 5.

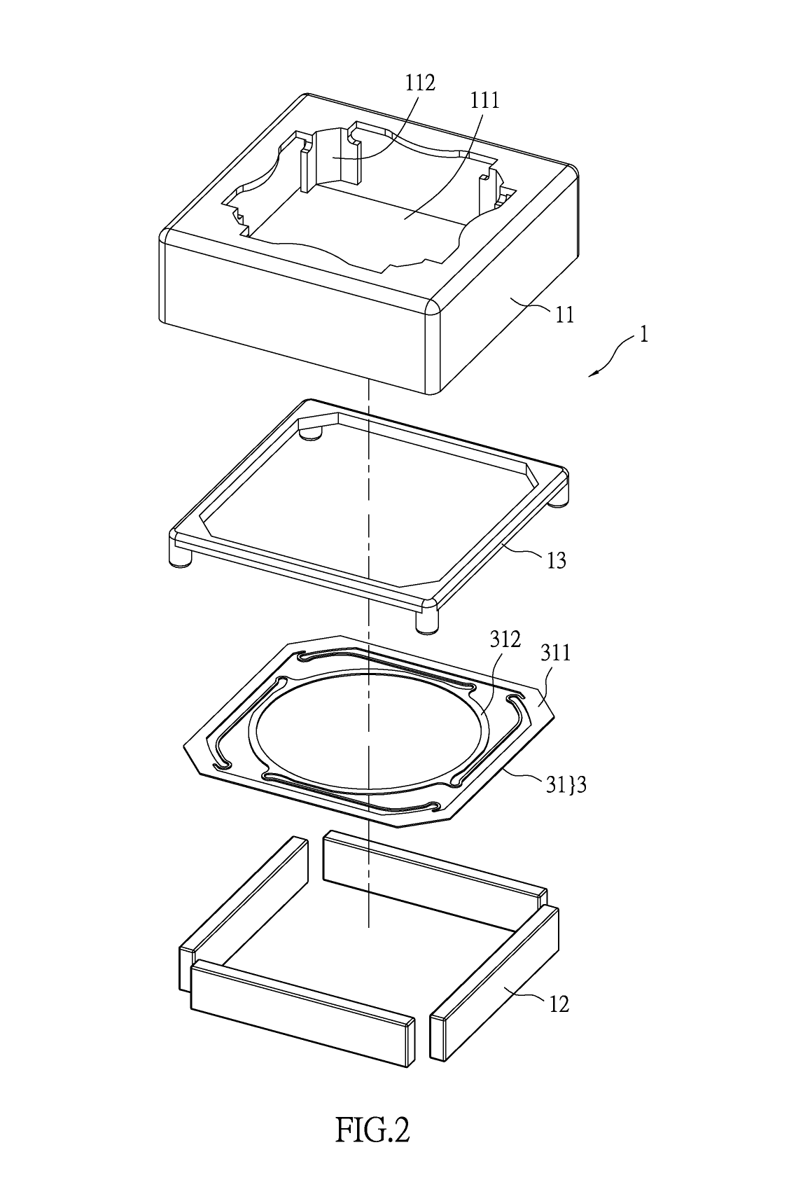

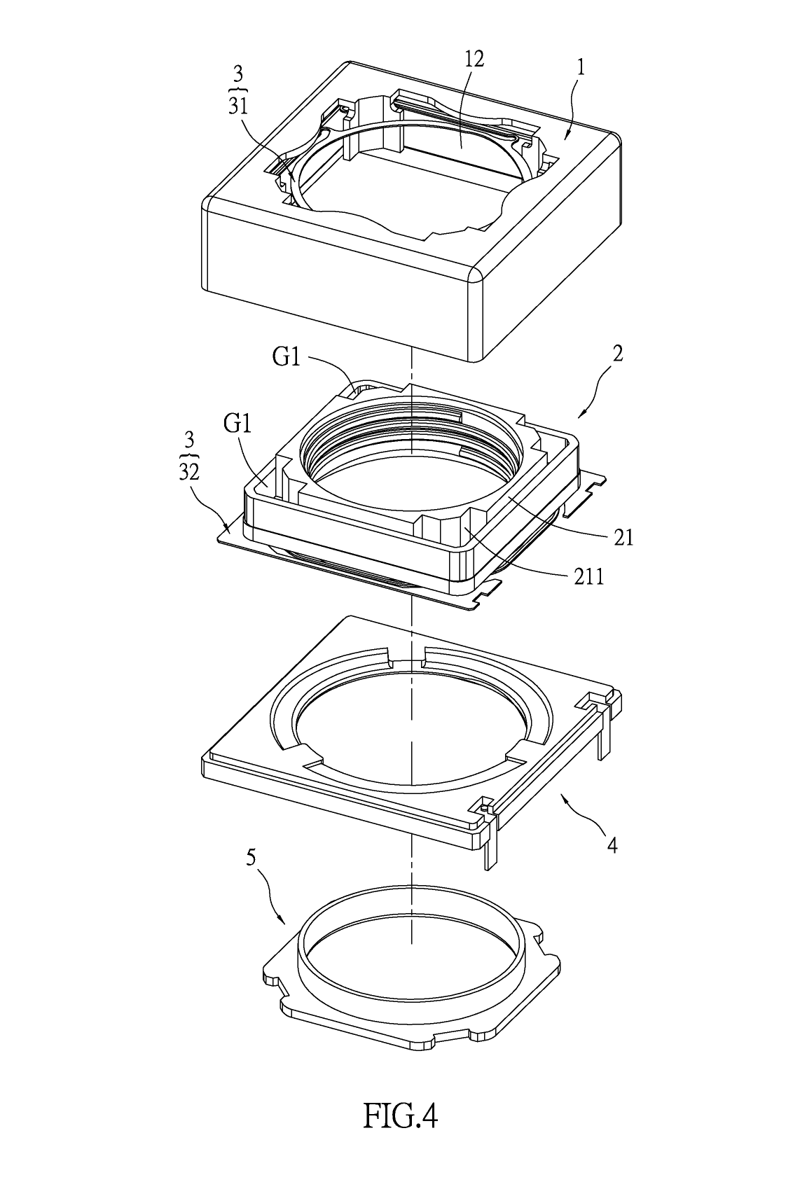

Referring FIGS. 2 to 4, the fixed module 1 includes a case 11 and a magnet module 12 being contiguous to the internal wall of the case 11. The case 11 is preferably made of metallic materials. The magnet module 12 preferably has a plurality of magnets and in the instant embodiment there are four magnets. The magnets are mounted on the inner walls of the case 11.

The mobile module 2 includes a lens holder 21 and a coil 22 coupled to the outer edge of the lens holder 21. The lens holder 12 is movably disposed in the case 11. The coil 22 is mounted on the lens holder 12 and positioned to correspond to the magnet module 12. When an electrical current is applied to the coil 22, a magnetic force is generated between the coil 22 and magnet module 12.

The spring module 3 abuts the fixed module 1 and the mobile module 2. Specifically, the spring module 3 includes an upper spring 31 and a lower spring 32. The upper spring 31 defines fixed edges 311 and mobile edges 312. Similarly, the lower spring 32 defines fixed edges 321 and mobile edges 322. The mobile edges 322 of the lower spring 32 abut the bottom rim of the lens holder 21 while the fixed edges 321 are mounted on the base 4 or case 11. The mobile edge 312 of the upper spring 31 abuts the rim of the lens holder 12. The fixed module 1 further includes a spacer 13 that presses against the fixed edge 311 of the upper spring 31 in cooperation with the magnet module 12. The spring module 3 can act as the conductive pole of the coil 22. When the current passes through the coil 22, the spring module 3 controls the height of the lens holder 12 and provides a predetermined restoring force. Specifically, the configuration of the fixed and mobile edges 311, 312, 321, 322 of the spring module 3 is not limited by the instant embodiment. The shape of the springs may vary according to practical application as long as the position of the mobile edge is confined when deformed and the springs should be stable and robust in motion.

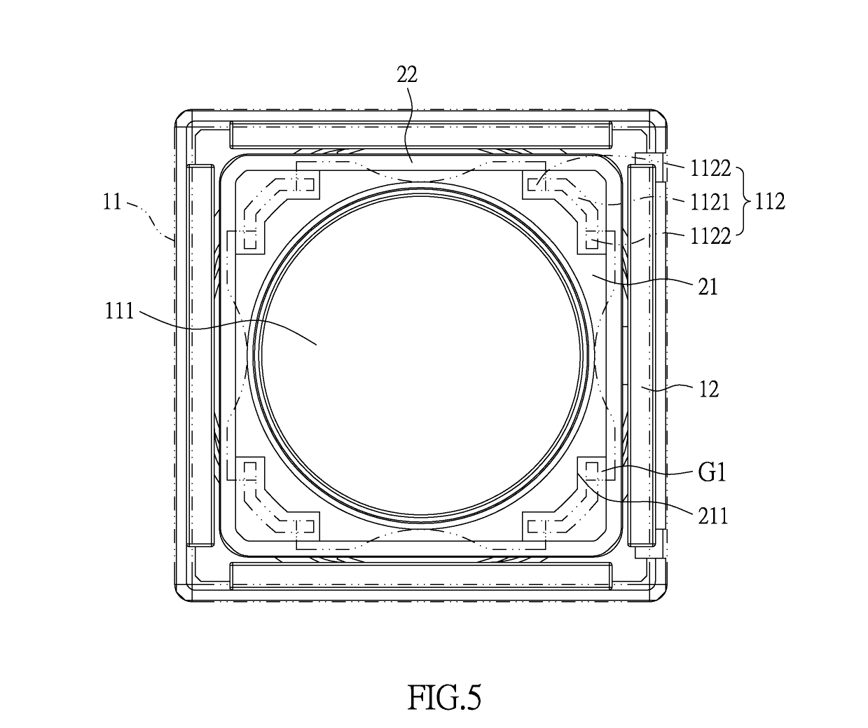

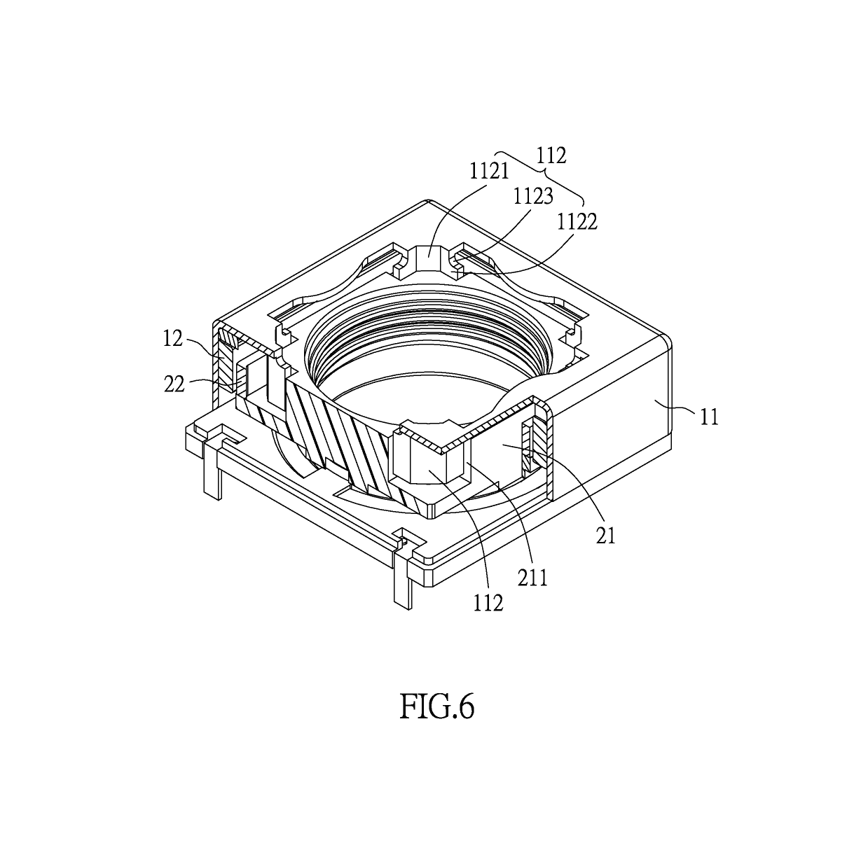

Referring to FIGS. 5 and 6, the case 11 is substantially quadrilateral and hollow. The case 11 has an opening 111 and each corner thereof is formed with a magnet guiding tab 112. In the instant embodiment, the opening 111 defines four corners and four magnet guiding tabs 112 are formed accordingly. The magnet guiding tabs 112 are preferably integrally formed with the case 11.

Furthermore, the magnet guiding tabs 112 extend into a space G1 defined by the outer wall of lens holder 21 and the coil 22. As shown in FIG. 5, the magnet module 12 is arranged along the contour of the lens holder 11 while having gaps in between each magnet. The magnet guiding tabs 112 are cooperatively positioned toward the gaps created between each magnet 12. Each magnet guiding tab 112 has a backbone 1121 and a pair of wing portions 1122 stretching from the backbone 1121. The pushing force generated by the magnetic force of VCM actuator is in positive proportion to the current going through the coil 22, and is affected by the corresponding area and magnetic flux between the coil 22 and the magnet module 12. The pushing force is also associated to the property of the VCM actuator, for example, reaction time and power consumption. However, gaps are created around the corner region by the arrangement of magnet module 12, and the magnetic field efficiency generated by the coil 22 is related to the presence of the gaps. In the instant embodiment, the magnet guiding tabs 112 has the backbone 1121 positioned toward the gaps between the magnets and the pair of wing portions 1122. The pair of wing portions 1122 respectively extends toward and is parallel to adjacent magnets. The magnetic field efficiency of the coil 22 at the corners is enhanced because the extended wing portions 1122 concentrate the magnetic effect and flux. The magnet guiding tabs 112 ensure the magnetic direction and condense the magnetic flux going through the coil 22. Hence, given the same amount of current, the VCM actuator of the instant disclosure generates stronger and more stable pushing force.

The lens holder 21 has four contacting faces 211 configured to meet the contour of the magnet guiding tabs 112. Therefore, if the VCM actuator is dropped on the floor, deformation is less likely to occur because the magnet guiding tabs 112 and the contacting faces 211 of the lens holder 21 are contiguous. The overall strength of the VCM actuator is improved by the substantially continuous wall. When a lens is screwed into the lens holder 21, the magnet guiding tabs 112 and the contacting faces 211 of the lens holder 21 can sustain greater torsion and therefore deformation of the spring module 3 is avoided.

Specifically, in the instant embodiment, the case 11 and the magnet guiding tabs 112 are integrally formed by drawing metallic materials. In the drawing process, the wing portions 1122 of the magnet guiding tab 112 are prone to breakage because of intense force concentration. The wing portions 1122 have to be thinner to avoid the breakage. The top rim of each wing portion 1122 is therefore thinned to form a round corner 1123 which enhances the strength and prevents breakage.

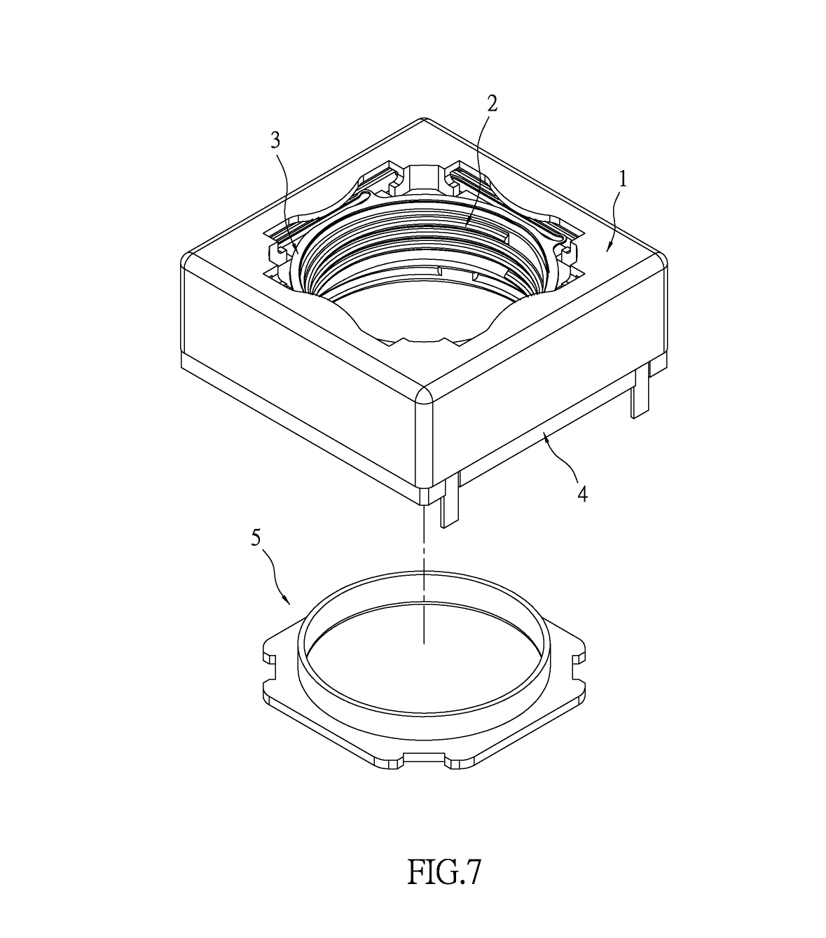

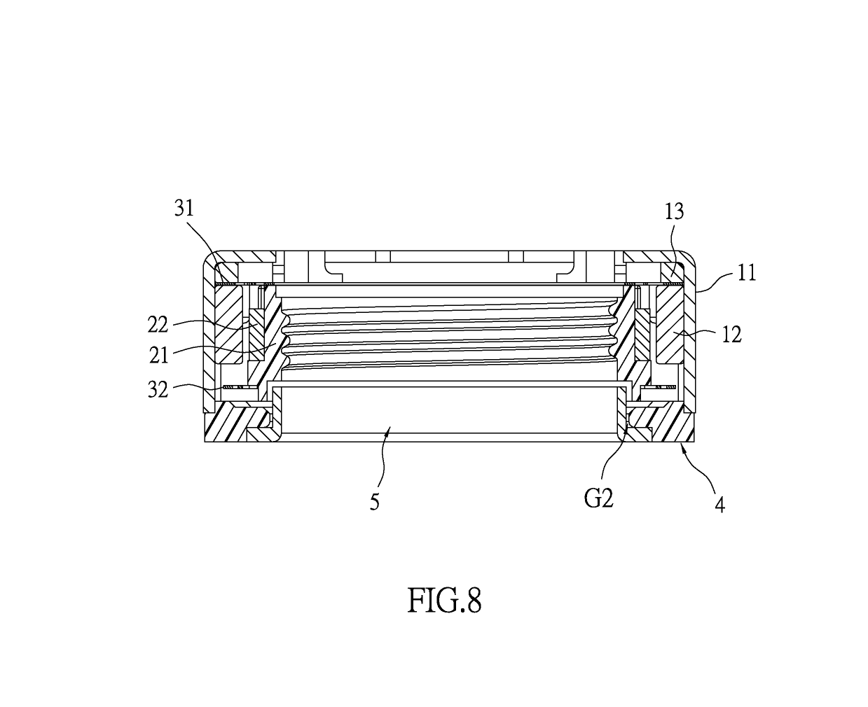

Referring to FIGS. 7 and 8, the VCM actuator of the instant disclosure further includes a base 4 and a dust-proof ring 5. The base 4 is disposed at the bottom of the case 11. The dust proof ring 5 is coupled to the base 4. An annular dust proof groove G2 is created between the dust proof ring 5 and the base 4. The dust proof groove G2 attracts dust therein. In addition, the dust proof ring 5 and the base 4 are bonded by double-sided tape or adhesive materials. Foreign particles or dust can be attached to or stuck along the edge of the dust proof groove G2. The image sensor (not shown) underneath the dust proof ring 5 is therefore protected and the image quality is ensured.

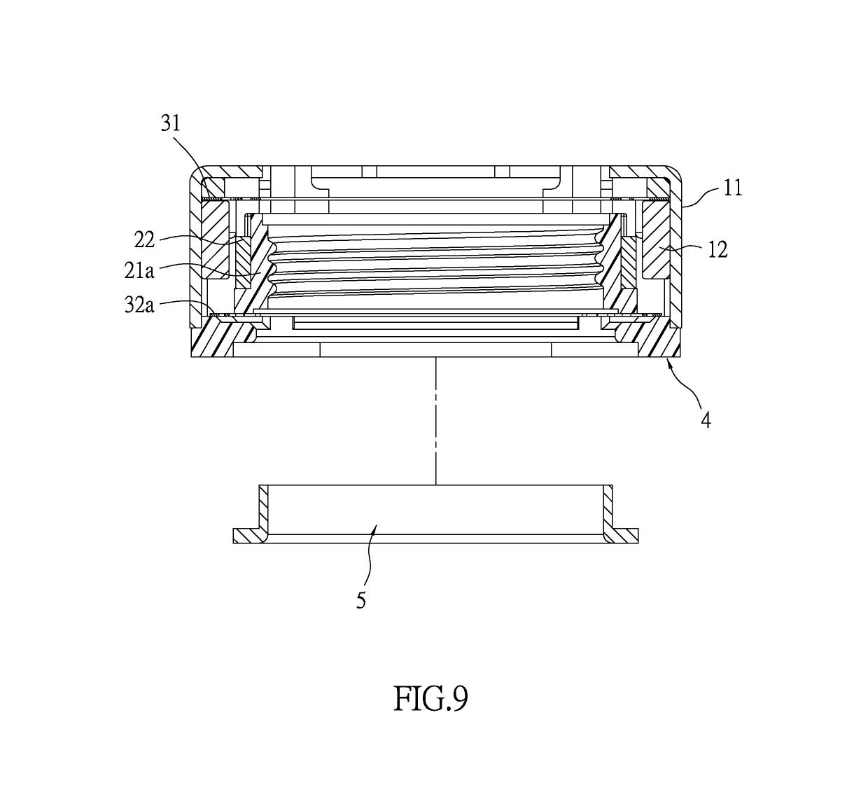

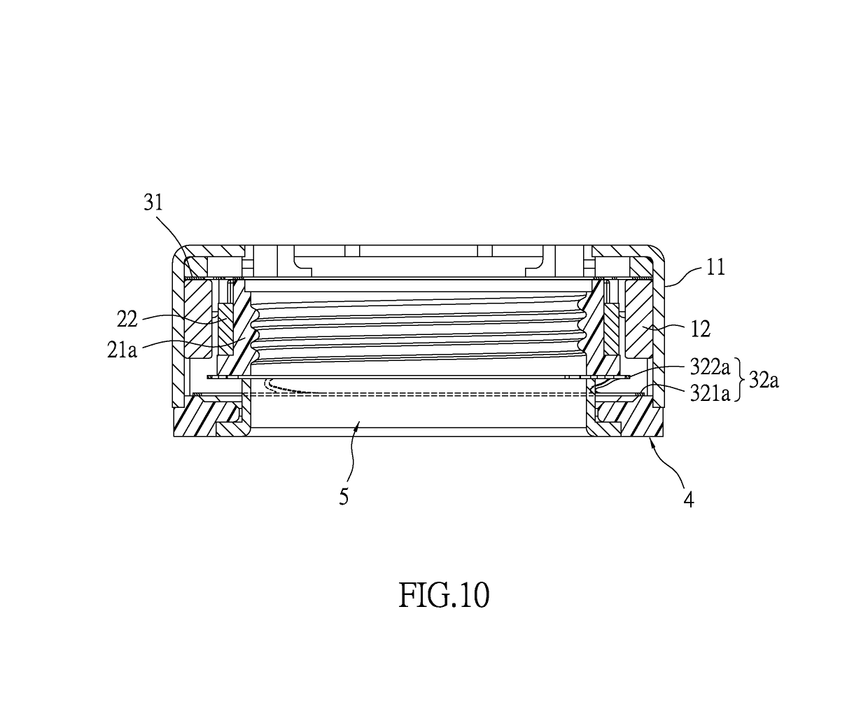

Referring to FIGS. 9 and 10, in another embodiment, the lower spring 32a and the top rim of the base 4 are parallel. The mobile edge 322a of the lower spring 32a abuts the bottom rim of the lens holder 21 while the fixed edge 321a is fastened to the top rim of the base 4. When the dust proof ring 5 is coupled to the base 4, the lens holder 21 is lifted high. Furthermore, the mobile edge 322a of the lower spring 32, abutting the lens holder 21, is deformed by the force from the dust proof ring 5 and a pressure is applied to the lens holder 21 thereby. As a result, the lens holder 21 is more stable in its up and down motion. The dust proof ring 5 is used to elevate the lens holder 21 and at the same time pressure the lower spring 32. The height of the dust proof ring 5 may vary so as to change the predetermined pressure applied to the lower spring 32.

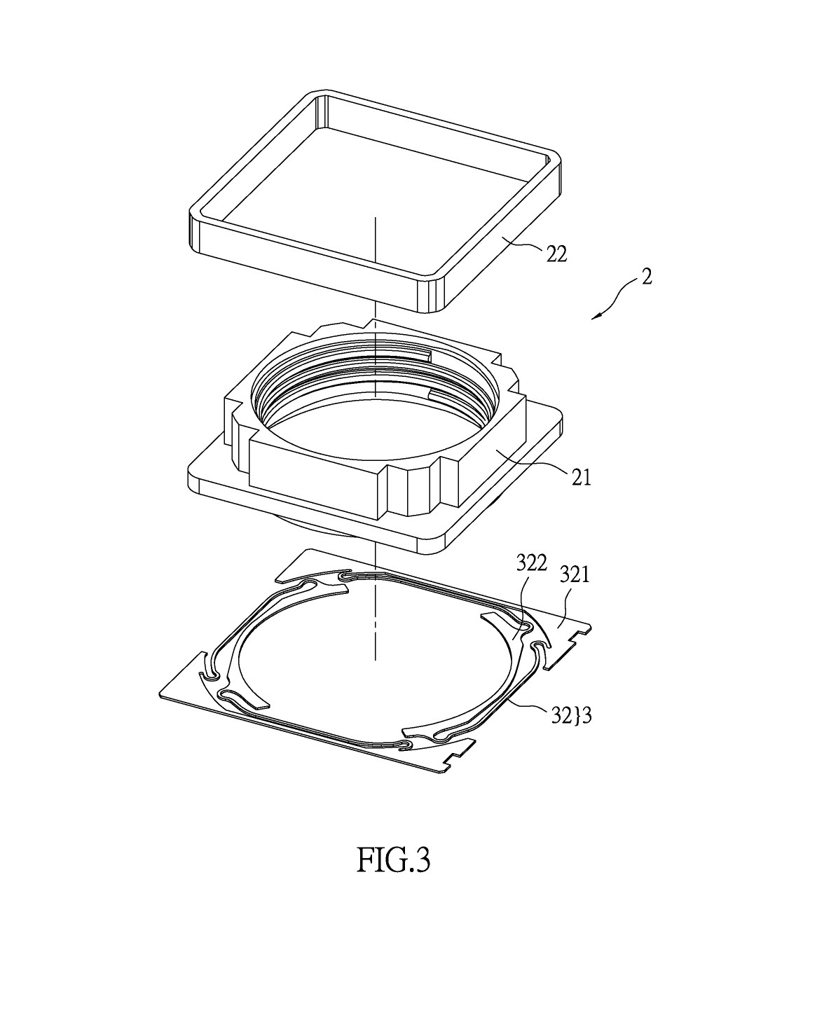

Referring to FIGS. 2 to 4 in conjunction with FIG. 7, the method of manufacturing the VCM actuator is provided in the instant embodiment. In step (a) a case 11, spacer 13, an upper spring 31 and magnet module 12 are provided. The case 11 is the foundation of the structure and the spacer 13, upper spring 31 and magnet module 12 are disposed in the case 11 in succession and a first half product is completed (as shown in FIG. 2). In step (b), a lens holder 21, a coil 22 and a lower spring 32 are provided. The lens holder 21 is the foundation and the coil 22 and the lower spring 32 are disposed in the lens holder 21 in succession and a second half product is completed (as shown in FIG. 3). In step (c), a base 4 is provided. The first half product of step (a) and the second half product of step (b) are assembled with the base 4 to form a provisional VCM actuator. It is worth noting that foreign particles or dust may be attached to the VCM actuator. Therefore in step (d), the semi-finished VCM actuator is cleaned by blowing air or rinsing with water. A dust proof ring 5 is then coupled to the base 4 (as shown in FIG. 7) yet the dust proof ring 5 may be omitted according to design requirement. The dust proof ring 5 and the base 4 are separated such that the provisional VCM actuator can be easily cleaned. The surface of the dust proof ring 5 is sticky and the dust proof ring 5 is attached to the base 4 such that the dust proof ring 5 is capable of collecting foreign particles. Additionally, when the dust proof ring 5 is coupled to the base 4, the lens holder 21 is lifted and a pressure is created. By having different heights of dust proof ring 5, the strength of pressure may vary as well.

In conclusion, the VCM actuator has magnet guiding tabs formed at the corners of the case and each magnet guiding tab has the pair of wing portions extending from the backbone. The magnetic field efficiency, driven by the electromagnetic field, of the coil at the corner region is enhanced thereby. The extending wing portions guide the magnetic field and enhance the flux. The direction of magnetic field is ensured by the presence of the magnet guiding tabs and the flux is denser. The VCM actuator generates more stable and powerful pushing force under the same current. Furthermore, the plurality of the contacting faces of the lens holder is in structural cooperation with the guiding tabs. Specifically, the magnet guiding tabs and the contacting faces of the lens holder are contiguous such that the VCM actuator can sustain stronger torsion and impact. Moreover, the annular dust proof groove formed between the dust proof ring and the base can collect or stick foreign particles therein and improve dust collection.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A voice coil motor actuator for a lens and driving the lens for focusing comprising:
a fixed module including a case and a magnet module disposed along the inner side of the case;
a mobile module including a lens holder and a coil looping the lens holder, (wherein) the lens holder being (is) movably disposed in the case and the coil being (is) fastened to the lens holder and positioned corresponding to the magnet module; and
a spring module abutting the fixed module and the mobile module;
wherein the case has an opening and along the rim of each corner of the opening a magnet guiding tab is formed, the guiding tabs extend to a space between the lens holder and the coil and are positioned toward the gaps created by the magnet module, and each magnet guiding tab has a backbone and a pair of wing portions extending from the backbone.

2. The voice coil motor actuator according to claim 1, wherein the magnet module includes a plurality of magnets and the wing portions of each magnet guiding tab are respectively parallel to the magnets.

3. The voice coil motor actuator according to claim 2, wherein the top rims of the wing portions respectively define round corners.

4. The voice coil motor actuator according to claim 1, wherein the spring module includes an upper spring and a lower spring and each of the upper and lower springs has a fixed edge and a mobile edge.

5. The voice coil motor actuator according to claim 4, wherein the mobile edge of the lower spring abuts the bottom rim of the lens holder, the fixed edge of the lower spring is fastened to the base or the case, the mobile edge of the upper spring abuts the top rim of the lens holder and the fixed module further includes a spacer abutting the fixed edge of the upper spring in cooperation with the magnets.

6. The voice coil motor actuator according to claim 1, wherein the periphery of the opening of the case defines four corners and the magnet guiding tabs are integrally formed with the corners.

7. The voice coil motor actuator according to claim 1, wherein the outer side of the lens holder is formed with a plurality of contacting faces being respectively contiguous and in structural cooperation with the magnet guiding tabs.

8. A voice coil motor actuator for a lens and driving the lens for focusing comprising:
a fixed module including a case and a magnet module disposed along the inner side of the case;
a mobile module including a lens holder and a coil looping the lens holder, the lens holder being movably disposed in the case and the coil being fastened to the lens holder positioning to the magnet module;
a spring module abutting the fixed module and the mobile module;
a base coupled to the bottom of the case; and
a dust proof ring coupled to the base and an annular dust proof groove defined by the dust proof ring and the base;
wherein the case has an opening and along the rim of each corner of the opening a magnet guiding tab is formed, the guiding tabs extend to a space defined by the lens holder and the coil and are positioned toward the gaps created by the magnet module, and each magnet guiding tab has a backbone and a pair of wing portions extending from the backbone.

9. The voice coil motor actuator according to claim 8, wherein the magnet module includes a plurality of magnets and the wing portions of each magnet guiding tab are respectively parallel to the magnets.

10. The voice coil motor actuator according to claim 9, wherein the top rims of the wing portions respectively define round corners.

11. The voice coil motor actuator according to claim 8, wherein the spring module includes an upper spring and a lower spring and each of the upper and lower springs has a fixed edge and a mobile edge.

12. The voice coil motor actuator according to claim 11, wherein the mobile edge of the lower spring abuts the bottom rim of the lens holder, the fixed edge of the lower spring is fastened to the base or the case, the mobile edge of the upper spring abuts the top rim of the lens holder and the fixed module further includes a spacer abutting the fixed edge of the upper spring in cooperation with the magnets.

13. The voice coil motor actuator according to claim 8, wherein the periphery of the opening of the case defines four corners and the magnet guiding tabs are integrally formed with the corners.

14. The voice coil motor actuator according to claim 8, wherein the outer side of the lens holder is formed with a plurality of contacting faces being respectively contiguous and in structural cooperation with the magnet guiding tabs.

15. A method of manufacturing a voice coil motor actuator comprising the following steps:
(a) providing a case, a spacer, an upper spring and a magnet module, the case being the foundation and the spacer, upper spring and magnet module being disposed in succession in the case as a first half product;
(b) providing a lens holder, a coil and a lower spring, the lens holder being the foundation and the coil and the lower spring being disposed in the lens holder in succession as a second half product;
(c) providing a base and assembling the first and second half products with the base to form a provisional voice coil motor actuator; and
(d) blowing air and rinsing with liquid to wash the provisional voice coil motor actuator and coupling a dust proof ring to the lens holder to elevate the lens holder and deform the lower spring to create a pressure on the lens holder.
